(19) United States
(12) Patent Application Publication
(10) Pub. No.: US 2003/0178305 A1
(43) Pub. Date: Sep. 25, 2003

(54) PH glass membrane and sensor

(76) Inventors: Lauren M. Catalano, Wrentham, MA (US); Ellen Candela, Cohasset, MA (US); Kenneth S. Fletcher, Hartford, CT (US); Michael M. Bower, Wareham, MA (US); David N. Skinner, Milton, MA (US); John P. Connelly, (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/283,615

(22) Filed: Oct. 30, 2002

Related U.S. Application Data
(63) Continuation-in-part of application No. 10/121,392, filed on Apr. 12, 2002.
Application No. 10/121,392 is a continuation of application No. 09/541,358, filed on Mar. 31, 2000, now Pat. No. 6,495,012.
(60) Provisional application No. 60/333,893, filed on Nov. 28, 2001.
(60) Provisional application No. 60/332,629, filed on Nov. 21, 2001.
(60) Provisional application No. 60/403,146, filed on Aug. 13, 2002.

(51) Int. Cl. G01N 27/26

(52) U.S. Cl. 204/433

(57) ABSTRACT

A pH sensor including a reference electrode, a measuring electrode operatively connected to said reference electrode, a fluid conduit for containing an electrolyte in electrolytic contact with said reference electrode, a reservoir in fluid communication with said fluid conduit, a reference junction encasing said reference electrode, and an external junction, wherein said electrolyte comprises a viscous silica suspension to maintain a flow of said electrolyte from said reservoir to reduce inward diffusion through said external junction.

### RELATED APPLICATION INFORMATION

This application is a continuation-in-part of U.S. patent application Ser. No. 10/121392, filed Apr. 12, 2002, which is a continuation of U.S. patent application Ser. No. 09/541358 filed Mar. 31, 2000, both of which are hereby incorporated by reference in their entirety.

This application also claims the benefit of priority to Provisional Patent Application 60/333,893, filed Nov. 28, 2001, Provisional Patent Application 60/332,629, filed Nov. 21, 2001, and to Provisional Patent Application 60/403,146, filed Aug. 13, 2002, all of which are hereby incorporated by reference in their entirety.

### BACKGROUND

A basis of the electrometric measurement of pH is the development of a potential gradient across a membrane of specific composition, when interposed between solutions having different concentrations of hydrogen ions. The potential developed across the membrane is quantitatively related to the concentration gradient of hydrogen ion and can be applied to a known measuring circuit to measure the pH of the sample. Because the potential developed across the glass is measured, electrolytic contacts must be made to the solutions on either side of the membrane. The potentials generated by these contacts are controlled using, for example, Ag/AgCl reference electrodes with controlled concentrations of potassium chloride (KCl) solution.

The conventional, external reference electrode has two components that contribute to the total potential measured across the cell: a thermodynamic potential and a liquid junction potential. The thermodynamic potential is derived from the electrochemical half-cell, whereas the liquid junction potential is derived from the difference in the ionic composition of the internal salt bridge electrolyte and the process solution being measured. For example, where the reference electrode half-cell reaction is:

Ag+Cl⁻=AgCl+e

the potential generated may be fixed by: (1) controlling the concentration of chloride ion, that is, Cl⁻, at a constant value; and (2) preventing interfering ions in the process solution from approaching the reference half-cell. In prior reference electrodes, these conditions are typically achieved by filling the reference electrode with potassium chloride (KCl), often within an internal chamber, which is connected to a salt bridge using an internal ceramic barrier. In such electrodes, electrolytic contact between the salt bridge and the process solution is made via an external ceramic barrier, and the salt bridge is stationary or non-flowing. In this configuration, both the liquid junction and the half-cell potential may be compromised during ingress of the process solution into the internal salt-bridge and reference half-cell solutions. Thus, accurate measurements require that cell voltage varies only with the concentration of the ion of interest, and that the reference electrode potential remain constant, unaffected by the composition of the process solution. In fact, it is known that the reference electrode is often the cause of poor results obtained from measurements with ion-selective electrodes. See, for example, Brezinski, D. P., Analytica Chimica Acta, 134 (1982) 247-62, the contents of which are hereby incorporated by reference.

In addition, the development of process sensors has tended toward probes with smaller diameters. This trend has made the construction of highly accurate and stable sensors more difficult. For example, in certain sensor designs, positioning the reference electrode further away from the process solution has resulted in decreased accuracy, due to decreased thermal accuracy. Thus, it would be desirable to have a sensor with increased stability and accuracy of measurements which decreases or eliminates the ingress of process solution. Durability of sensors may also depend on the composition of the glass membrane of the electrode. Glass pH electrodes comprising glass membranes may be subject to acid error in acidic solutions, and may be also subject to alkaline error caused for example, by cations in basic solutions. There is also a need for improved sensors having smaller diameters while also reducing the process-wetted portion of the sensor.

In view of these considerations, there is a need for a reference electrode that reduces or prevents back-flow of contaminants or materials from the process solution through the external junction. There is also a need to provide a durable, economical and versatile reference electrode that is easy to fabricate, use, install, calibrate and maintain.

### SUMMARY

The present disclosure provides a sensor with a reference electrode and a flowing electrolyte. The application provides for sensors that operate with relatively high accuracy and stability by reducing ingress of contaminants from a process solution through the external junction of the sensor. Disclosed is a sensor having a reservoir which provides flow of an electrolyte. The instant application also provides a sensor having a non-metallic solution ground. The sensor can include a resistance temperature device bonded to a non-metallic solution ground.

In one embodiment, the application provides a sensor having a reference electrode, a flowing electrolyte in electrolytic contact with the reference electrode, a reservoir for providing flow of the electrolyte, a reference junction, and an external junction in electrolytic contact with the reference electrode and wherein the electrolyte flows between the junctions.

In another embodiment, the disclosure provides a sensor having a reference electrode, an electrolyte in electrolytic contact with the reference electrode, a reservoir for providing the electrolyte, an external junction, and a porous member in electrolytic contact with the reference electrode and disposed between the external junction and the reservoir, to control a flow of the electrolyte from the reservoir to reduce inward diffusion through the external junction. In one embodiment, the percentage loss of the electrolyte in the sensor is less than about 15% after about 14 temperature cycles, wherein said temperature cycle comprises heating the sensor to about 65° C. for about 24 hours, and then cooling to about 25° C. In an embodiment, the sensor includes an orifice between an upper reservoir and a lower reservoir. The orifice may comprise a plastic. In an embodiment, the sensor comprises a pH glass membrane.

The disclosure also provides a glass composition for use in a pH glass membrane. The glass composition may comprise about 33 to about 36 mole percent Li₂O; about 0.5 to about 1.5 mole percent of at least one oxide selected from the group consisting of Cs₂O and Rb₂O; about 4 to about 6 mole percent of a lanthanoid oxide; about 4 to about 6 mole percent of at least one oxide selected from the group consisting of Ta₂O₅ and Nb₂O₅; and, about 54 to about 58 mole percent SiO₂. In an embodiment, the glass composition may comprise about 34 mole percent Li₂O; about 1.0 mole percent Cs₂O; about 5 mole percent La₂O₃; about 5 mole percent Ta₂O₅; and about 55 mole percent SiO₂.

The pH glass membrane can have a thickness of about 0.01 inches to about 0.03 inches. In an embodiment, the pH glass membrane can have a substantially domed shape.

In an embodiment, the disclosure provides a sensor that includes a reference electrode, an electrolyte in electrolytic contact with the reference electrode, a reservoir for providing the electrolyte, an external junction, wherein the electrolyte in contact with the reference electrode includes a viscous silica suspension to maintain a flow of the electrolyte from the reservoir to reduce inward diffusion through the external junction.

Sensors disclosed herein may be used to measure various parameters of a fluid, for example, ion concentration. In one embodiment, the sensor is a pH sensor, for example, a sensor to measure hydrogen ion concentration, having a reference electrode, a flowing electrolyte in electrolytic contact with the reference electrode, a reservoir for providing flow of the electrolyte, a reference junction, and an external junction. In one embodiment, the sensor includes a porous member in electrolytic contact with the reference electrode. The electrolyte flow can be restricted based on the porous member that can be disposed between the reservoir and the external junction, and additionally and/or optionally can be disposed at an intermediate location, that, for example, can divide the reservoir into two or more reservoir areas. The pH electrode can include a non-metallic ground disposed at a sensing surface. In an embodiment, the pH sensor includes a resistance temperature device bonded to the non-metallic ground. In one embodiment, the non-metallic ground extends beyond the end of the lower housing and the non-metallic ground is substantially conical in shape.

The disclosure also provides a method of manufacturing a sensor having a resistance temperature device and a non-metallic ground, the method including melting the non-metallic ground in contact with the resistance temperature device and allowing the non-metallic ground to solidify in contact with the resistance temperature device, thus ensuring optimal thermal contact.

### BRIEF DESCRIPTION OF THE DRAWINGS

FIG. 1a is a cross-section of one embodiment of a sensor according to the present disclosure, taken along section line 1a-1a of FIG. 1b.

FIG. 1b is an end view of the embodiment depicted in FIG. 1a and depicts the sensing surface of the sensor.

FIG. 2a is a cross-section of another embodiment of a sensor according to the present disclosure, taken along section line 2a-2a of FIG. 2b, and showing aspects of the resistance temperature device and the solution ground.

FIG. 2b is an end view of the embodiment depicted in FIG. 2a and depicts the sensing surface of the sensor.

FIG. 3a is a cross-section of one embodiment of a sensor according to the present disclosure and depicts a solution ground that is substantially conical in shape.

FIG. 3b is a view of the embodiment depicted in FIG. 3a showing aspects of the resistance temperature device and a solution ground that is substantially conical in shape.

FIG. 4 is a graph comparing the response time of the temperature resistance device of a sensor of the disclosure with the response time of some commercially available sensors.

FIG. 5a is a cross-section of one embodiment of a sensor, taken along section line 1a-1a of FIG. 5b.

FIG. 5b is an end view of an embodiment according to FIG. 5a and depicts a sensing surface of the sensor.

FIG. 6 is a cross-section of one embodiment of a sensor according to the present disclosure.

FIG. 7 shows representative examples of different shaped pH glass membranes: a) spherical; b) domed; and c) flat.

FIG. 7d shows a geometric representation of a spherical cap.

FIG. 8 shows, for a representative pH glass membrane formulation, the resistivity based on glass membrane thickness and shape.

### DETAILED DESCRIPTION

For convenience, before further description, certain terms employed in the specification, examples, and appended claims are collected here. These definitions should be read in light of the reminder of the disclosure and understood as by a person of skill in the art.

The articles “a” and “an” are used herein to refer to one or to more than one (i.e. to at least one) of the grammatical object of the article. By way of example, “an element” means one element or more than one element.

The term “lanthanide” or “lanthanoid” is commonly understood to mean a series of elements in the periodic table generally considered to range in atomic number from lanthanum (57) to lutetium (71) inclusive.

This disclosure provides a sensor having a reference electrode for use with electrochemical ion measuring electrodes, for example, pH electrodes. The sensor has a flowing electrolyte that provides electrolytic contact between an internal reference half-cell and a process wetted junction, for example, an external junction. This flow of electrolyte prevents back flow of contaminants or other materials from a process solution through the external junction and into the electrolyte, thereby reducing unwanted liquid junction potentials in the external junction. Further, this arrangement may reduce the likelihood of reference half-cell contamination. A sensor can be manufactured with a relatively small diameter of for example, about 0.75 in (1.9 cm). In addition, sensors may be designed to reduce the length of the process wetted portion, for example, to about 0.5 in (1.3 cm).

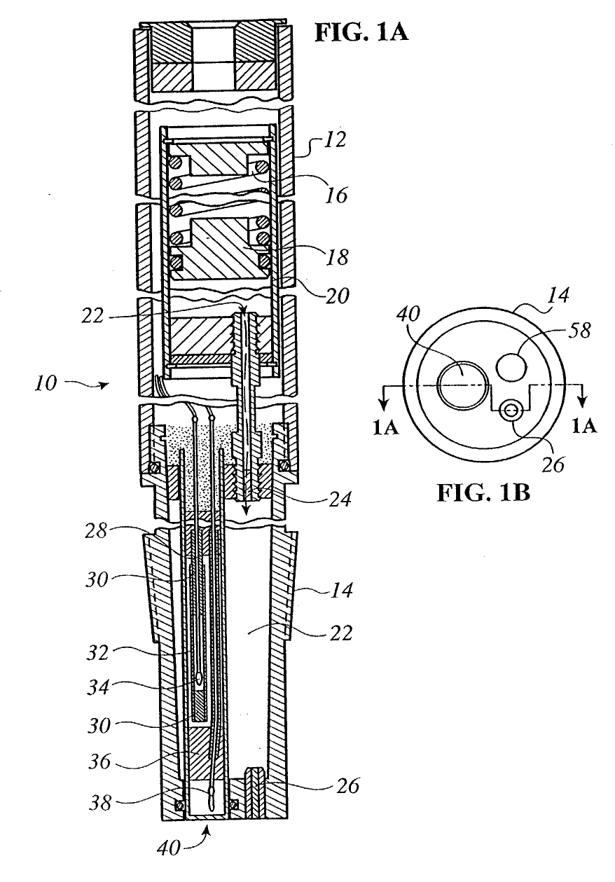

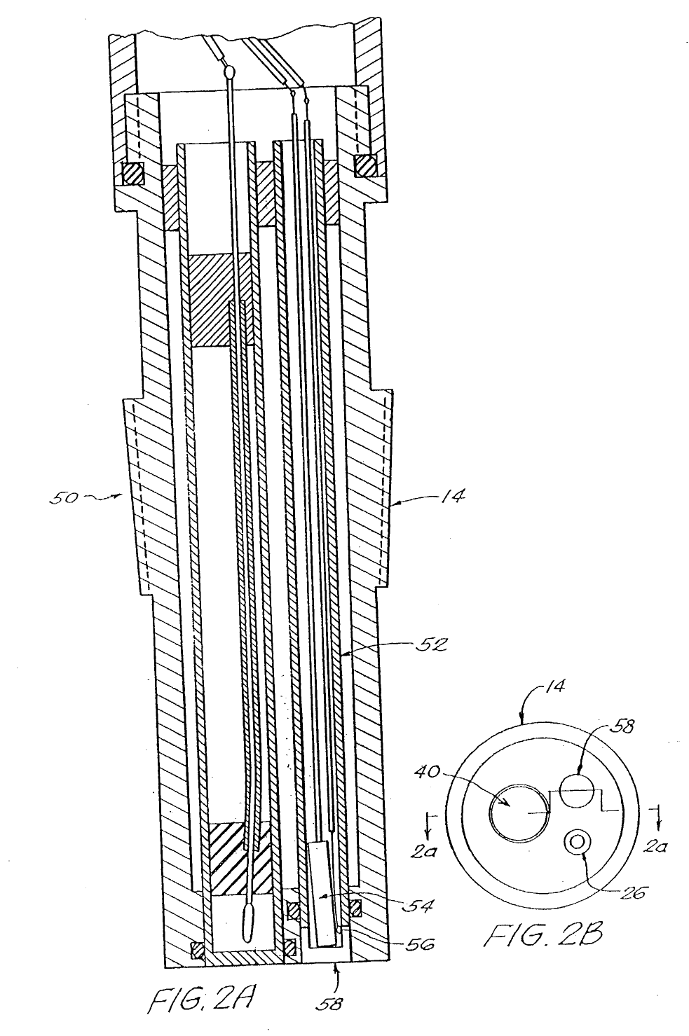

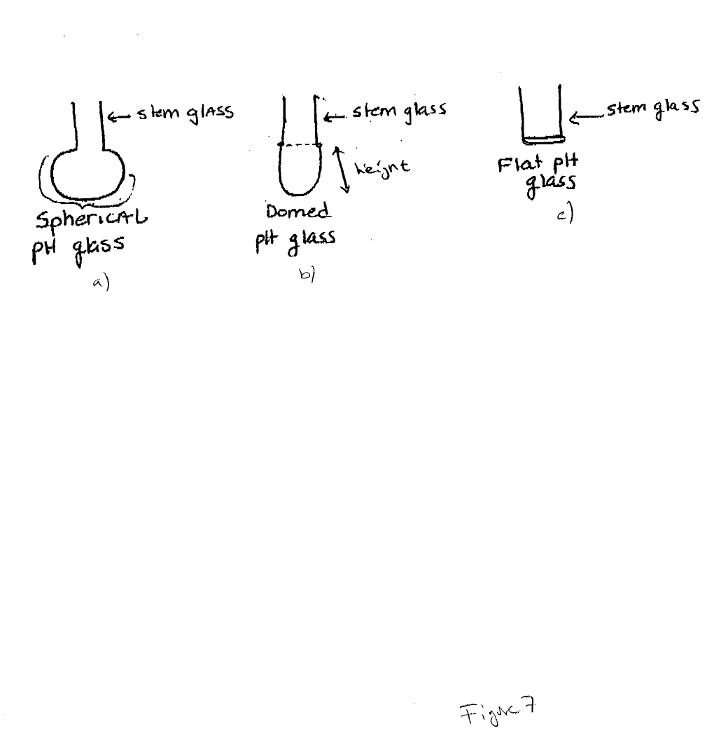

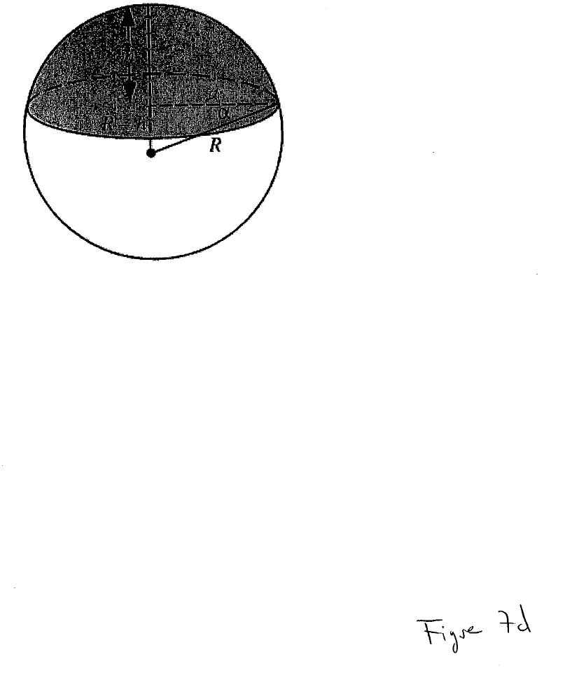

A sensor 10 according to one embodiment has, as shown in both FIGS. 1a and 1b, and FIGS. 5a and 5b, an upper housing 12 and a lower housing 14, and includes a pressurized reservoir 20, for electrolyte 22 which can be acted upon by a piston 18. The illustrated embodiment in FIGS. 1a and 1b and in FIGS. 5a and 5b includes a spring 16 acting on the piston 18, to create positive flow of electrolyte 22. FIG. 6 shows an embodiment without a spring.

A porous member 24 is provided between the reservoir 20 and the external junction 26. In one embodiment, the porous member 24 can be disposed at an intermediate location to divide the reservoir 20 into two or more reservoir areas 20, 22. In the illustrated sensor, the porous member 24 is disposed in an orifice 150 that may include a plastic material, which may, for example, include polycarbonate, polyethylene, polypropylene, polyurethane, poly ether ether ketone (PEEK), polyvinylchloride (PVC), or acrylonitrilebutidiene styrene (ABS). In one embodiment, the orifice may comprise a poly ether ether ketone.

In one embodiment, the porous member 24 is made of a glass material. Reference electrode 34 can be encased by internal junction 32, which may be a cation exchange membrane. The cation exchange membrane may be a sulphonated polytetrafluoroethylene membrane, for example, commercially available membrane from DuPont under the trade name NAFION®. Glass membrane 40 surrounds measuring electrode 38, which may be operatively connected to reference electrode 34.

FIGS. 2a and 2b show a sensor 50, which includes a resistance temperature device 54. As shown in the illustrated embodiment, ground wire 56 is operatively connected to solution ground 58. In one embodiment, solution ground 58 is made of a non-metallic material. The solution ground 58 may be made of a conductive polymer, such as conductive polyvinyldifluoride, sold by Elf Atochem, N. A. under the trade name KYNAR®. The solution ground 58 may be bonded to insulating ground tube 52.

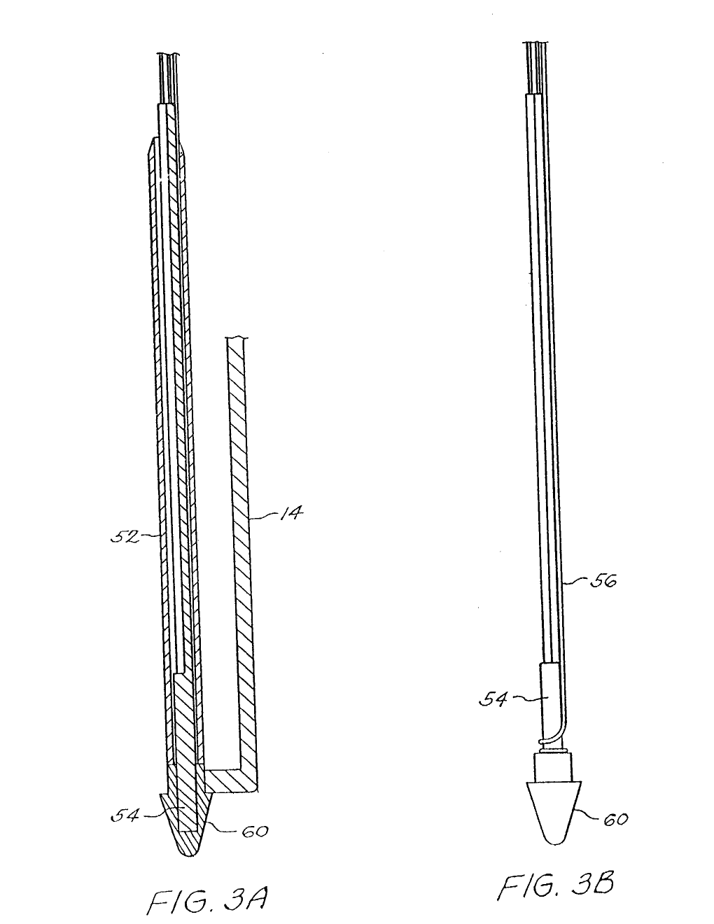

FIGS. 3a and 3b show another sensor which includes a substantially conical non-metallic ground 60. As further shown in the illustrated embodiment, the substantially conical non-metallic ground 60 may extend beyond the end of lower housing 14. The resistance temperature device 54 may extend into the substantially conical non-metallic ground 60, which is bonded to ground tube 52. FIG. 3b illustrates ground wire 56 in operative connection with the resistance temperature device 54.

FIG. 5a shows a sensor having an orifice 150 which may allow electrolyte to flow from an upper reservoir 20a to a lower reservoir 20b, although those of ordinary skill in the art will recognize that the disclosed systems and/or methods do not require an orifice and/or upper or lower reservoirs. In the FIG. 5a and 5b embodiments, the porous member 24 can be disposed to control electrolyte flow from a reservoir 20, 20b to the external junction 26, where the porous member 24 may further be in electrolytic contact with the reference electrode 34. FIG. 5a illustrates a sensor further comprising a stem glass 41 and a domed shape pH glass membrane 40.

In one embodiment, sensor 10 includes a reservoir 20 for creating and controlling flow of an electrolyte 22. The reservoir 20, as provided herein, can be pressurized. The reservoir 20 may be pressurized in a variety of ways, for example by using a pressure regulator, for example, a pressure-controlled or a mechanically-controlled sequence valve. For example, pressure may be imparted by a piston 18 which subjects the electrolyte 22 to a controlled pressure. In an embodiment, the piston 18 is a spring actuated piston. In one embodiment, pressure is not controlled. Other fluid motive means known in the art may be used in accordance with sensors of this disclosure. For example, an external pressure source may be used to impart flow of the electrolyte, for example, a pump may be used to pump electrolyte through a capillary. In an embodiment, the fluid motive means is a mechanism which creates a pressure drop across a porous member 24. In an embodiment, the flow rate of electrolyte 22 is limited to less than about 20 μL/day. The pressure exerted on the electrolyte 22 may be about 200 psig.

The disclosure provides a sensor 50 having a non-metallic ground 58 positioned to contact a process solution. The ground 58 may be disposed at a sensing surface of the sensor, for example, any surface which is in contact with the process solution. In an embodiment, the non-metallic ground 58 is an electrically conductive polymer. The non-metallic ground 58 may be made of polyvinyldifluoride, for example, such as that commercially available from Elf Atochem, N. A. under the trade name KYNAR®. A non-metallic ground of electrically conductive polymer can be bonded to a non-conductive polymer tube 52, which may provide an optimal thermal contact.

The disclosure provides a sensor having a resistance temperature device 54 that is bonded to a non-metallic ground 58. The disclosure also provides a method of manufacturing a sensor 50 having a resistance temperature device 54 bonded to a non-metallic ground 58. The method includes melting the non-metallic ground 58 in contact with the temperature device 54 and allowing the non-metallic ground 58 to solidify in contact with the device 54. The geometrical shape of the non-metallic ground 58 is not particularly limited. In one embodiment, the non-metallic ground extends beyond the end of the lower housing 14 and can additionally and/or optionally be substantially conical in shape.

In an embodiment, the sensor can include an internal or reference junction 32 which includes a cation exchange membrane. The cation exchange membrane may be a sulphonated polytetrafluoroethylene membrane, such as, for example, a commercially available membrane from DuPont under the trade name NAFION®. In one embodiment, a cation exchange membrane, for example, a membrane that is permeable to many cations and polar molecules, may be used as a material for a reference junction due in part to its ability to pass charge as positively charged cations. The cation exchange membrane may likewise be substantially impermeable to anions and non-polar species.

In one embodiment, a cation exchange membrane encases the reference electrode 34. Encasing the reference electrode 34 in a cation exchange membrane may serve to maintain the chloride level, for example, and reduce effects of contamination from external sources. The cation exchange membrane may also maintain the Ag⁺ level, for example, due to the fact that Ag⁺ forms a negatively charged complex of the form Ag(Clₙ)⁻⁽ⁿ⁻¹⁾. This may also inhibit the AgCl from reaching the external junction 26, where decreased KCl levels due to diffusion of the external process may result in the precipitation of AgCl. Such precipitation may cause clogging of the junction and a resulting noisy liquid junction potential. The reference electrode may include a seal 30. The seal may comprise a silicone based material.

For a sensor 10, which uses, for example, AgCl-saturated, 1 M KCl electrolyte solution 22, the cation exchange membrane may be prepared by immersion in a solution of 1 M KCl. This process may create an electrical junction across the membrane, wherein potassium ions associate with the membrane. In operation, when a charge is drawn from an attached measuring device, potassium ions from the internal solution associate with the membrane, causing potassium ions to dissociate from the other side of the membrane. In contrast, conventional porous ceramic junctions may require negative ion movement in the opposite direction to maintain charge balance. Thus, while the flowing electrolyte 22 reduces back diffusion of contaminants through the external junction 26, even if contaminants were to reach this membrane, there would be little effect on the reference potential until the concentration builds to an appreciable fraction of the relatively high cation, for example, the K+concentration.

According to the present disclosure, flow of electrolyte 22 may be controlled, in part, by a porous member 24 positioned between the reservoir 20, 20b and the external junction 26. In one embodiment, the porous member can be disposed between the external junction 26 and the reservoir 20, 20b to control a flow of the electrolyte from the reservoir 20, 20b such that the porous member is in electrolytic contact with the reference electrode. Electrolyte flow may be controlled to a flow rate, for example, in the range of about 0.1 to about 20 μL/day. This can be achieved by creating a pressure differential across a porous membrane comprising a microporous glass. The microporous glass can have a pore size of about 40 to about 200 Angstroms.

In one embodiment, the porous member comprises VYCOR® glass (Corning Glass code 7930) including the glasses described in T. H. Elmer, “Porous and Reconstructed Glasses,” Engineered Materials Handbook, Vol. 4: Ceramics and Glasses, which is hereby incorporated by reference. One of ordinary skill in the art will recognize that glasses such as VYCOR® can include a pore size distribution that can render flow rates that may be substantially constant.

The flow of electrolyte may be controlled in part by a porous member 24, which comprises a viscous fluid. Viscous fluids, for example, include fluids with inorganic fillers or gelling agents such as silicas, including fumed silica, alumina, and celluloses, including carboxyethylcellulose ether. In an embodiment, the porous member comprises a viscous fumed silica suspension. The porous member may, in some embodiments, comprise substantially the same material as the electrolyte 22.

As the illustrated embodiments show, the reference electrode 34 may be isolated from the process by at least an external liquid junction, and in some embodiments, for example, those illustrated in FIGS. 5a and 5b, this isolation can also be provided by the porous member 24. As discussed herein, the external junction 26 may be a relatively low porosity ceramic, for example, an alumina ceramic. For example, based on a maximum internal fluid capacity of 8 mL and a useful life of 1-year, the maximum permissible flow rate may average no greater than about 20 μL/day.

In an embodiment, the internally pressurized design can provide an outward flow of electrolyte 22 through the porous member 24 to overcome inward diffusion of process through the external junction 26. The effectiveness of an approximately 1 μL/hr flow rate to prevent inward diffusion was demonstrated experimentally. A multiple syringe pump capable of accurately delivering controlled flows in the range 0.5 to 2.0 gL/hr was connected into flow cells containing M/871 CR conductivity cells. The cells were connected to 870ITCR transmitters and a data logger to monitor conductivities in the range 0 to 100 μS/cm. The diffusion barrier ceramic was placed at the output of the flow cell at a position up-stream and in close proximity to the conductivity sensor. At the start of each experiment, the system, syringe, flow cell and external tube containing diffusion barrier were filled with deionized, deaerated water and the assemblies were placed in a thermostated bath to eliminate thermal expansion effects on the flow-rates. To ensure against leaks (this minuscule flow-rate is virtually impossible to detect visually), the output flow was monitored using 1/32″ id capillary tubing (volumetric displacement, 12.5 μL/inch). In each case the system was allowed to operate for several days to establish a baseline of conductivity with time, to ensure, for example, no conductivity change due to inwards leaks from the temperature bath or from corrosion within the flow cells. To start the salt test, the exit capillary on external tube was carefully withdrawn using a syringe and replaced with 1 M KCl. The flow measuring tube was purged of liquid and then reinstalled. No increase of conductivity at this point signified outflow and, thus, prevention of diffusion in.

The electrical resistance of three samples of Ceramtek 244B type alumina ceramics were tested for electrical resistance and the results are shown in Table I. The standard procedure measures the voltage drop created by a polarizing current of 0.2 μA across the ceramic immersed in 1 M KCl using two NAFION encased Ag, AgCl/1.0 M KCl reference assemblies a non-polarizable electrolytic contacts.

TABLE I

| | V1^{a} (mV) | V2^{b} (mV) | R, Kohm^{c} | R, Kohm^{corr.} |
|---|---|---|---|---|
| NAFION/NAFION | 0.20 | 0.36 | 0.80 | N/A |
| Sample 1 | 0.89 | 3.60 | 13.55 | 12.75 |
| Sample 2 | 1.07 | 4.61 | 17.7 | 16.90 |
| Sample 3 | 0.66 | 4.33 | 18.35 | 17.55 |

NAFION/NAFION represents the resistance of the two NAFION assemblies without the junction between them and is essentially the combined resistance of the two NAFION barriers.
^{a}Measured voltage without applied current
^{b}Measured voltage with 0.2 μA applied
^{c}R, Kohm = {(V² − V¹)/(2E−6)} · 10⁻³, where the V's are expressed in mV
Kohm^{corr} represents ceramic after subtracting 0.80K from NAFION/NAFION.

Although the external junction 26 may not typically be used to control flow rate in some uses, the external junction 26 may present a restriction to diffusion with minimum electrical impedance. Experiments were conducted to establish an empirical relationship between volumetric flow rate and ceramic junction electrical resistance. For example, flow can be reduced and electrical resistance across the ceramic is limited to less than 20 Kohms. Reference conditions for flow rate measurements were determined by mounting the ceramics in glass tubes to ensure flow through, rather than around, the ceramic. Ceramics were mounted in Corning Type 0120 glass (potash soda lead) and deionized water, pressurized with 10 psig air provided the flow. Flow was measured as the linear displacement of the air/water interface along a tube having an id of 1/32″ (12.5 μL/in). Data for two ceramic materials are shown in Table II.

TABLE II
Flow Rates and Electrical Resistance of External Diffusion
Ceram-tek 244B, 0.053″ diam × 0.150″ long
Average Flow Rate (uL/hr)

| | |
|---|---|
| Sample 1 | 22.6 |
| Sample 2 | 24.4 |
| Sample 3 | 24.2 |

Average Resistance, three samples, 15.7K

In industrial applications, temperature cycling of the process may produce process solution thermal pumping into, and electrolyte solution thermal pumping out of, the reference solution chamber, through the external barrier 26. This phenomenon may shorten useful cell life by creating unstable junction potentials, and through loss of electrolyte 22. This effect can be reduced by using a higher flow restrictor such as micro porous VYCOR® glass 24 (e.g., Corning Glass code 7930). This micro porous glass 24 can be disposed between the reference electrode 34 and the external junction 26 to reduce the amount of fluid that may otherwise pass through the more porous ceramic frit 26, while maintaining electrical resistance </=20 kΩ.

Experiments were conducted to determine the effect the VYCOR® 24 has on the reduction of electrolyte loss during temperature cycling. The experiment was conducted using sensors built with the VYCOR® 24 installed and comparing them with sensors built with out the VYCOR® 24, and subjecting them to a series of temperature cycles. Temperature cycles were achieved by placing the experimentals in a stainless steel bomb with pH buffer inside. The bomb was then placed into a heat chamber and heated to 65° C. for 24 hours, then reduced down to 25° C. The amount of electrolyte loss was measured through addition of electrolyte to the reservoir 22 after each cycle. Reference resistance was measured while connecting the sensor 10 to an Intelligent pH analyzer where the measured value was achieved using the solution ground and reference termination. A number of temperature cycles were performed and loss of electrolyte along with reference resistance are shown in Table III.

TABLE III

| ID | % Loss | Reference Resistance |
|---|---|---|
| 1 (ceramic/gel) | 17.4% | 20 kQ |
| 5 (ceramic/gel) | 20.5% | 20 kQ |
| 14 (ceramic/VYCOR ®) | 13.6% | 20 kQ |
| 15 (ceramic/VYCOR ®) | 20.0% | 20 kQ |
| 17 (ceramic) | 74.2% | 20 kQ |
| 18 (ceramic) | 50.0% | 20 kQ |

The results from Table III indicate a decrease in electrolyte loss while maintaining minimal electrical impedance, when either, for example, VYCOR® 24, or gelled electrolyte, is positioned between the reference electrode and the external junction 26, for example, a ceramic frit.

A variety of reference electrodes and electrolytes are known and may be used with the disclosed sensors. An ordinarily skilled artisan can select an electrode/electrolyte combination for a particular application without undue experimentation. In an embodiment, a pH sensor can include a Ag/AgCl, 1 M KCl, Sat AgCl reference electrode that is isolated from the process by an external junction and an internal reference junction which includes a NAFION® membrane barrier. A positive outflow of electrolyte may counteract inward diffusion of process and additionally may inhibit clogging of the external junction by the process solution. The diffusional transport of process solution to the reference junction may be further restricted by a relatively long path length between the external and reference junctions.

The reference electrode 34 can produce and maintain a substantially constant or non-polarizable electromotive potential that is unaffected by the small electrical current requirement of the measuring device to which it is connected. Further, the reference electrode may maintain its stability over an entire temperature and pressure range requested and should be protected from exposure to the various chemical species in the large variety of processes in which these sensors are applied.

Silver and silver chloride, in contact with a fixed concentration of KCl, may be used for a pH sensor. When properly constructed, its potential may be non-polarizable at, the current densities employed and its temperature dependence closely obeys theoretical predictions. At equilibrium, the following electrochemical reaction fixes the electrode potential:

AgCl+e=Ag°+Cl⁻

Silver chloride, plated on a silver wire may provide the reference terminal. When current is drawn through the cell, this reaction can proceed either to the right or left depending on current direction. The potential will remain constant as long as sufficient AgCl remains on wire, the chloride concentration remains constant and extraneous ionic species do not approach the proximity of the electrode and compete with the chloride ion.

Silver chloride solubility is related to concentration of KCl used in the salt bridge. The solubility of AgCl in 0, 1, 2, 3, and 4 M KCl is 0.01, 0.1, 0.6 2.2, and 8.0 mM, respectively. The increase in solubility is due to formation of negatively charged complex ions having the general formula Ag(Cln)−(n−1). Use of electrolyte 22 having high concentration of KCl is desirable for limiting electrical resistance over the path that isolates the internal reference junction 32 physically from the process. Also, the ability of KCl to form relatively clean junctions with the process samples with relatively small electrical junction potentials is desirable. However, when the concentration of KCl is diluted in the porous junction, AgCl precipitates and clogs it, causing spurious and erratic liquid junction potentials. Thus, a 1 M KCl solution is preferable because, at this concentration, the solubility of AgCl is roughly 1% of that in 4 M KCl. This concentration of electrolyte should be used throughout the probe; in the glass electrode internal reference electrode (here adjusted to pH 7), in the working reference electrode and in the electrolyte 22. In this way, the isopotential point for the system may be established at pH7.

If desired, the electrolyte used may contain an anti-freeze compound, such as a glycol, to provide freeze protection. For example, the electrolyte used may be 0.33 M KCl with 40 vol. % ethylene glycol, or 1 M KCl with 25% propylene glycol. NAFION® membrane resistance may vary significantly with degree of hydration and it is therefore necessary to condition the membrane in the electrolyte. This may be done by heating the NAFION membrane in the electrolyte for about one hour at about 95-100° C. The membrane may then be stored in a closed container of this electrolyte until used.

The pH function of the glass membrane of the disclosed pH sensor may depend on its bulk composition. The glass membrane presents a stable ionic exchange equilibrium with hydrogen ions in contact with the internal and external surfaces. Electrolytic transport of cations, for example, Na⁺ or Li⁺, may provide sufficient conductivity across the membrane to allow measurement of this potential by the connected analyzer with sufficiently high input impedance. Silicate (SiO₂) may form a stable and durable anionic framework in glass that provides ion exchange sites necessary for the pH function. In one embodiment, the pH glass formulations contain at least 50% SiO₂. This property may govern the ultimate temperature limits and chemical compatibility properties of pH glass membranes. Alkali metal ions, such as Li⁺, Na⁺, Rb⁺, and Cs⁺ may provide the mobile charge carriers that impart electrolytic conductivity to these glasses.

Formulations with Na⁺ may provide comparatively high conductivity, and hence low resistance glasses. Because of the relatively low bulk resistivity of this glass it is possible to fabricate this membrane in, for example, a “flat-glass” design for use in applications where protrusion of a fragile element into the process is objectionable. This glass membrane demonstrates an about ideal Nemstian response over the 2-12 pH range and 0-85° C. temperature range.

Lithia glasses (Li₂O) may have significantly less measurement error at high pH than soda glasses and significantly increased corrosion resistance at elevated temperature. Lithium ions, Li⁺, may be significantly less mobile in the glass yielding higher bulk resistivity. The high resistivity may suggest that the membranes be thinner and have larger area than would be practical with a flat-glass design. Glasses containing other Group I oxides such as Cs₂O or Rb₂O may improve membrane ruggedness and may also allow formation of thinner glass membranes.

The addition of a group VB ion, in the form of an oxide, for example, Ta⁺, which has greater mobility than Li⁺, may be added to in greater amounts which may achieve a tougher membrane with ultra low resistance and hence, faster response time. The ability of possessing low resistance and fast response times may allow for longer life and ease of use at ambient temperature after being exposed to cycles at elevated temperature.

In one embodiment, a glass composition is provided which comprises about 33 to about 36 mole percent of Li₂O; about 54 to about 58 mole percent SiO₂; about 0.5 to about 1.5 mole percent of at least one group 1 oxide selected from the group consisting of Cs₂O and Rb₂O; about 4 to about 6 mole percent of a lanthanoid oxide; and about 4 to about 6 mole percent of at least one group VB oxide selected from the group consisting of Ta₂O₅ and Nb₂O₅. In one embodiment, the group 1 oxide is Cs₂O. In another embodiment, the lanthanoid oxide is La₂O₃. In another embodiment, the group VB oxide is Ta₂O₅. This glass membrane composition may demonstrate an ideal Nernstian response over the 1-14 pH range and 0-120° C. temperature range.

Experimental evaluations of high temperature glass from the above formulation, identified as ‘C’ glass, are shown below in Table IV. The properties evaluated include electromotive efficiency, pH response time and resistance change with high temperature, 120° C., and autoclave cycling.

TABLE IV
Glass Resistance, Electrode Efficiency and Response Times with 20 autoclave cycles of 5
samples of C glass electrodes.
Stated performance specifications per CPS 1982 Rev B.

| | Specifications | Performance expectation after | |
|---|---|---|---|
| Test | when new | exposure to 120° C. | Results |
| Glass | <30 Mohm | Increase with exposure. Based on | Samples met requirements as |
| Resistance | | previous testing can increase as | received (avg. = 17 Mohm) |
| | | high as 500 Mohm after 20 | After 20 autoclave cycles resistance |
| | | autoclave cycles at 120° C. | increased as expected |
| | | | (avg. = 400 Mohm) |
| Electrode | >96% | Decrease with exposure. Useful | Samples met requirements as |
| Efficiency | | life has expired when < 80% | received (avg. = 98%) |
| | | | No apparent change in efficiency |
| | | | after 20 autoclave cycles (avg. = |
| | | | 97%). |
| Response | <30 sec for | Increase with exposure. Useful | Samples met requirements as |
| Time | 90% | life has expired when > 2 min for | received (avg. = 10 sec) |
| | | 90% | After 20 autoclave cycles response |
| | | | time increased (avg. = 35 seconds) |

A separate experiment was conducted to evaluate the same properties as those listed in Table IV, using a substantially constant high temperature flow loop. The intent of this evaluation was to determine the effect that high process temperature and moderate process pressure have on the pH glass membranes. A weak acid buffer solution was used as the process solution and temperature and pressures were held at 100° C. and 20 psi, respectively. The total number of hours each sensor was subjected to these conditions was approximately 300 to 390 hours, or about 380 to about 390 hours. For purposes of comparison, a number of other supplier's pH glasses were evaluated (denoted 1 and 2 in the following table). These glasses are used in current pH electrodes and were tested in that form. They are high temperature, low sodium error, glasses.

A pH sensor comprising a pH glass composition disclosed herein may have a short electrometric, pH, response time after being subjected to elevated temperature cycles. Fast and precise pH response may be critical to control a chemical process where small changes in pH may be detrimental if not detected effectively, due to sluggish pH response.

Experimental evaluations of this high temperature glass formulation and other supplier electrodes, for electromotive efficiency, resistance change and pH response times are shown in Table V.

TABLE V
Glass Resistance, Electrode Efficiency and Response Times after 388 hours at temperatures
reaching 100° C. (and 20 psi induced process pressure) of the DolpHin C domed glass electrodes
along with electrodes from two other high temperature pH Suppliers.

| | Supplier 1 (n = 3) | | Supplier 2 (n = 3) | | DolpHin C glass (n = 8) | |
|---|---|---|---|---|---|---|
| | When New | After 388 hrs | When New | After 388 hrs | When New | After 388 hrs |
| Glass | 699 | 4559 | 451 | 2975 | 25 | 641 |
| Resistance | | | | | | |
| (M ohm) | | | | | | |
| Electrode | 98% | 96.6% | 99.1% | 78.5% | 99.3% | 98.8% |
| Efficiency | | | | | | |
| (useful life has expired when < 80%) | | | | | | |
| Response | <15 sec | >3 min | <15 sec | >2.5 min | <15 sec | 38 sec |
| Time | | | | | | |
| (useful life has expired when > 2:00 minutes) | | | | | | |

The results exhibited in Table V show that ‘C’ glass outperforms two other high temperature glass suppliers. The pH response time for the C glass remains within an acceptable time frame after exposure to high temperatures. This property may be important with industrial processes that use clean in place (CIP) methods and require fast pH response time with temperature cycling.

An exemplary preparation of the high temperature “C” glass is presented in the following example. The amounts are listed in mole percent and the quantities listed make approximately 100 grams of glass powder.

### EXAMPLE

| Component | Mole % |
|---|---|
| SiO₂ | 55.3 |
| Li₂CO₃ | 34.0 |
| La₂O₃ | 4.7 |
| Ta₂O₅ | 4.9 |
| Cs₂CO₃ | 1.0 |

The components of the glass powder can be combined together until the appearance is homogeneous. The powder mixture can be placed in a clean crucible and can be melted using an electric furnace with temperatures reaching approximately 1300° C. for an amount of time to ensure a bubble free, homogeneous molten glass. A pH glass membrane can then be formed to a specified thickness and electrical resistance using, for example, a blowing tool and a chemically and electrically inert stem glass.

The resulting pH measuring electrode can then be prepared with an internal fill solution buffered to a pH 7, with KCl salt solution saturated with AgCl and a Ag/AgCl electrode immersed inside.

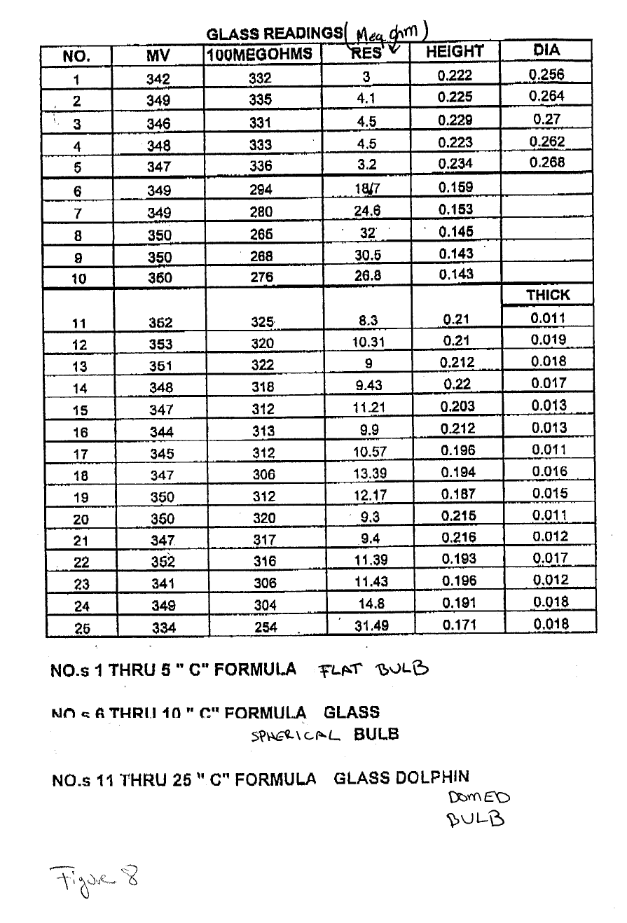

In one embodiment, a domed bulb glass membrane 40 is provided, as shown in FIG. 7. The domed bulb glass membrane includes a substantially spherical cap shape and may comprise a glass composition of the present disclosure. Geometrically speaking, a spherical cap can be understood herein to include at least a portion of a sphere that is bisected by a plane. The spherical cap can include a height, h, and a base radius, a. The sphere of which the spherical cap is part has a radius R. A spherical cap is illustrated for example in FIG. 7d. In one embodiment, the sphere/cap height, the radius of the sphere, and the base radius are not equal. In other embodiments, the glass membrane is a substantially spherical dome shape that has more surface area, for example, than a flat glass membrane. In an embodiment, the domed bulb glass membrane may include a substantially ellipsoidal shape.

In one embodiment, a pH glass membrane 40 may be formed to a specified thickness, shape, or electrical resistance using, for example, a blowing tool and a chemically and electrically inert stem glass 41. The stem glass may be a thin walled glass tube.

In an embodiment, the glass membrane 40 can have a thickness of about 0.01 inches to about 0.03 inches, or a thickness of about 0.015 inches to about 0.25 inches. FIG. 8 shows the resistance in Mohms as function of pH glass thickness and shape for the representative ‘C’ formula of the glass membrane.

When subject to a drop test, a domed glass membrane with the thickness disclosed herein may exhibit superiority over standard glass membranes. The glass electrodes disclosed herein can be held at twice the height and survive a drop test. This characteristic may be beneficial for example, from a manufacturing standpoint, and for example, from a user standpoint. Many industrial pH applications have solids present which may travel through the process pipeline and cause a protruding pH glass membrane to crack or break. While a flat glass membrane may avoid breakage, a flat glass membrane has less surface area than domed glass, and higher electrical resistance with shorter life expectancy and may not be specified for high temperature applications.

The geometric shape of the non-metallic ground in a sensor is not particularly limited. The nonmetallic ground may be either machined or made by injection molding according to procedures known in the art. In an embodiment, the non-metallic ground extends beyond the end of the sensor housing or body and into the process solution. In one embodiment, the geometric shape of such a ground is selected to provide a relatively large surface area exposed to the process solution. The non-metallic ground may having relatively thin walls. This combination of relatively large surface area and relatively thin walls may serve to reduce the response time of the resistance temperature device (RTD), and also may reduce the possibility of entrapment of any solids present in the process solution.

A sensor according to the disclosure was compared to certain commercially available sensors. Specifically, the speed of thermal response of a probe was compared with the speeds of thermal response for various commercially available pH probes. Briefly, for each probe, the speed of thermal response was measured by first determining the resistance of the RTD in the probe at ambient room temperature. Each probe was then placed in boiling water. The RTD resistance was then measured every 10 to 20 seconds, depending on the rate of response. The response time was defined as the time a give probe takes to read 90% of the change from ambient temperature to boiling water.

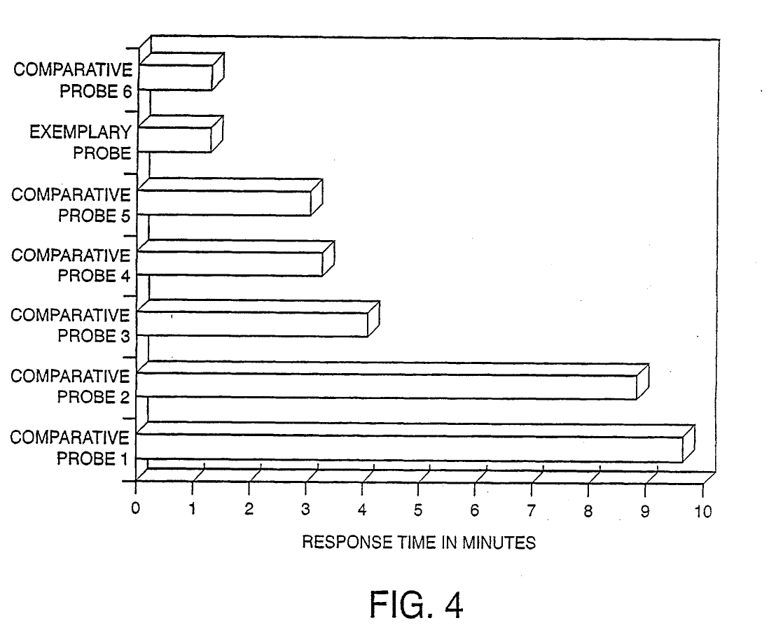

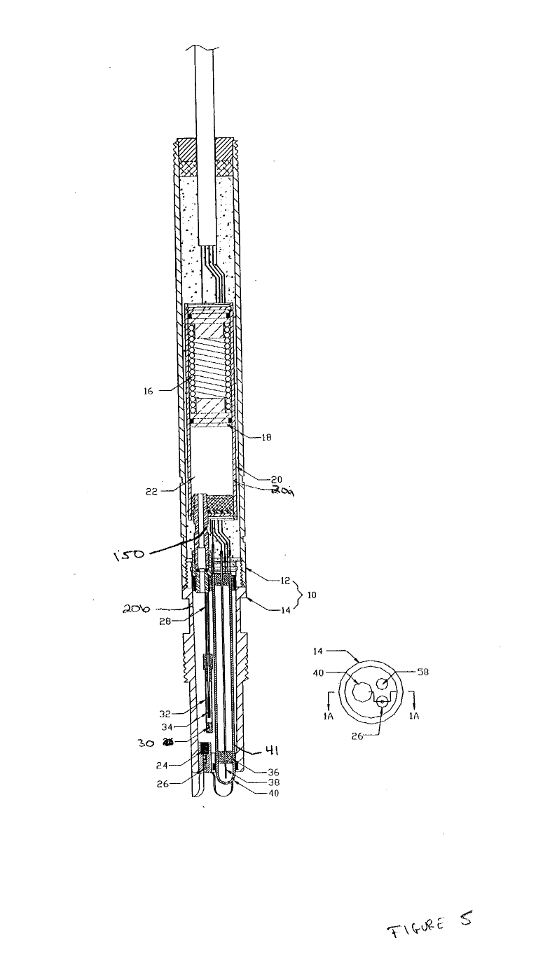

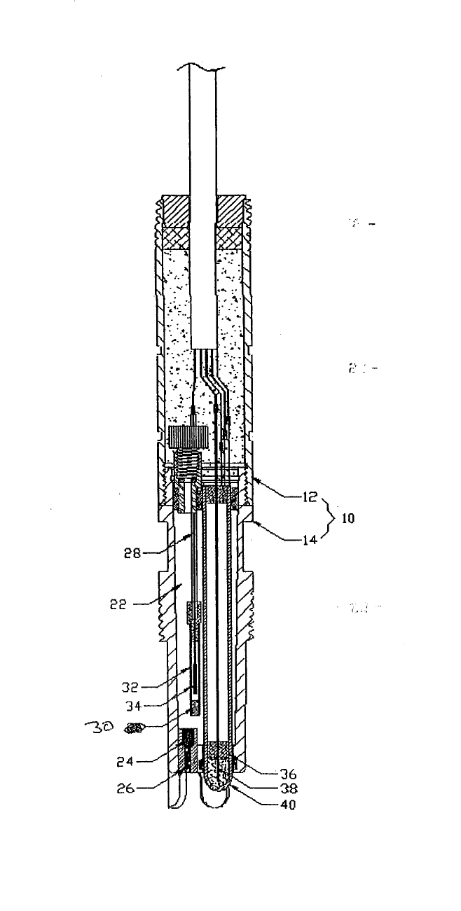

FIG. 4 and Table VI show a comparison of the response times of a sensor according to the disclosure with that of various otherwise commercially available probes. The exemplary probe used in the experiment was a sensor having a non-metallic solution ground extending beyond the end of the sensor housing and having a substantially conical shape. Each of Comparative Probes 1 through 5 is a plastic-bodied pH probe with the RTD positioned away from the process solution interface.

Comparative Probe 6 uses a glass/metal interface with the RTD to achieve its response time. From FIG. 4 and Table IV, the sensor provides increased response time as compared to conventional probes and is capable of thermal response times previously attainable only with a metallic interface.

TABLE VI
Comparison of Thermal Response Times for Various Probes

| Probe | Response Time (Min.) |
|---|---|
| Comparative Probe 1 | 9.6 |
| Comparative Probe 2 | 8.8 |
| Comparative Probe 3 | 4.0 |
| Comparative Probe 4 | 3.2 |
| Comparative Probe 5 | 3.0 |
| Comparative Probe 6 | 1.2 |
| Exemplary Probe | 1.2 |

Also provided herein is a method of manufacturing a sensor having a resistance temperature device (RTD) 54 and a non-metallic ground 58. An RTD/ground assembly was prepared as follows. A wire lead was wrapped around the body of an RTD to form a subassembly. This subassembly was then inserted into a piece of electrically conductive polymer (KYNAR®), using a slip/press fit. An insulating polymer piece was then placed over the subassembly. The inner diameter of the insulating polymer preferably provides a tight fit over the wire lead. The resulting assembly was placed in a metal heating block to melt the two polymer pieces to the RTD and wire. The process resulted in: (1) a hermetic seal between the polymer pieces; (2) an intimate electrical connection between the lead wire and the assembly; (3) a mechanical bond between the RTD and the assembly; and (4) an intimate thermal contact between the RTD and the non-metallic solution ground.

Incorporation by Reference

All patents, published patent applications and other references disclosed herein are hereby expressly incorporated herein in their entireties by reference. In case of conflict, the present application, including any definitions herein, will control.

Equivalents

Those skilled in the art will recognize, or will be able to ascertain using no more than routine experimentation, that the apparatus and embodiments described above may be modified without departing from the broad inventive concept described herein. Thus, the invention is not to be limited to the particular embodiments disclosed herein, but is intended to cover modifications within the spirit and scope of the present invention as defined by the appended claims.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

We claim:

1. A pH sensor comprising:
a reference electrode;
a measuring electrode operatively connected to said reference electrode;
a fluid conduit for containing an electrolyte in electrolytic contact with said reference electrode;
a reservoir in fluid communication with said fluid conduit;
a reference junction encasing said reference electrode;
an external junction; and
a porous member in electrolytic contact with said reference electrode, to control a flow of the electrolyte from said reservoir, wherein said porous member is disposed between said external junction and said reservoir.

2. The pH sensor of claim 1, wherein said porous member includes a glass material.

3. The pH sensor of claim 2, wherein said glass material comprises a pore diameter of about 30 to about 250 Angstroms.

4. The pH sensor of claim 3, wherein said glass material comprises a pore diameter of about 40 to about 200 Angstroms.

5. The pH sensor of claim 2, wherein said glass material comprises VYCOR®.

6. The pH sensor of claim 1, wherein said electrolyte includes a viscous fluid.

7. The pH sensor of claim 6, wherein said viscous fluid comprises a silica suspension.

8. The pH sensor of claim 7, wherein said silica suspension comprises fumed silica.

9. The pH sensor of claim 1, wherein said external junction comprises an alumina ceramic.

10. The pH sensor of claim 1, wherein percentage loss of the electrolyte is less than about 15% after about 14 temperature cycles, wherein said temperature cycles comprise heating to about 65° C. for about 24 hours and cooling to about 25° C.

11. The pH sensor of claim 1, further comprising an orifice between an upper reservoir and a lower reservoir.

12. The pH sensor of claim 11, wherein said orifice comprises a plastic.

13. The pH sensor of claim 1, wherein said measuring electrode further comprises a pH glass. membrane.

14. The pH sensor of claim 13, wherein said pH glass membrane has a substantially dome shape.

15. The pH sensor of claim 13, wherein said pH glass membrane comprises a glass composition comprising:
about 33 to about 36 mole percent Li₂O; about 0.5 to about 1.5 mole percent of at least one oxide selected from the group consisting of Cs₂O and Rb₂O; about 4 to about 6 mole percent of a lanthanoid oxide; about 4 to about 6 mole percent of at least one oxide selected from the group consisting of Ta₂O₅ and Nb₂O₅; and about 54 to about 58 mole percent SiO₂.

16. The pH sensor of claim 13, wherein said pH glass membrane has a thickness of about 0.01 inches to about 0.03 inches.

17. The pH sensor of claim 15, wherein said glass composition comprises about 34 mole percent Li₂O; about 1.0 mole percent Cs₂O; about 5 mole percent La₂O₃; about 5 mole percent Ta₂O₅; and about 55 mole percent SiO₂.

18. A pH glass membrane comprising a glass composition, said glass composition comprising: about 33 to about 36 mole percent Li₂O; about 54 to about 58 mole percent SiO₂; about 0.5 to about 1.5 mole percent of at least one group I oxide selected from the group consisting of Cs₂O and Rb₂O; about 4 to about 6 mole percent of a lanthanoid oxide; and about 4 to about 6 mole percent of at least one group VB oxide selected from the group consisting of Ta₂O₅ and Nb₂O₅;
wherein said pH glass membrane has a thickness of about 0.01 inches to about 0.03 inches.

19. The pH glass membrane of claim 18, wherein said group I oxide is Cs₂O.

20. The pH glass membrane of claim 18, wherein said lanthanoid oxide is La₂O₃.

21. The pH glass membrane of claim 18, wherein said group VB oxide is Ta₂O₅.

22. The pH glass membrane of claim 18, wherein said pH glass membrane has a substantially domed shape.

23. The pH glass membrane of claim 18, wherein said pH glass membrane has a resistivity between about 3 MΩ and about 32 MΩ.

24. The pH glass membrane of claim 23, wherein said pH glass membrane has a resistivity between about 10 MΩ and about 30 MΩ.

25. The pH glass membrane of claim 18, wherein said pH glass membrane has a resistivity below about 700 MΩ.

26. The pH glass membrane of claim 25, wherein said pH glass membrane has been exposed for more than about 300 hours to a temperature above about 95° C. and to a pressure above about 20 psi.

27. The pH glass membrane of claim 26, wherein a thermal response time is below about 40 sec.

28. The pH glass membrane of claim 18, wherein said glass composition comprises about 34 mole percent Li₂O; about 1.0 mole percent Cs₂O; about 5 mole percent La₂O₃; about 5 mole percent Ta₂O₅; and about 55 mole percent SiO₂.

29. The pH glass membrane of claim 18, wherein said pH glass membrane has a thickness of about 0.015 inches to about 0.025 inches.

30. A pH glass membrane comprising a glass composition, said glass composition comprising: about 33 to about 36 mole percent Li₂O; about 54 to about 58 mole percent SiO₂; about 0.5 to about 1.5 mole percent of at least one group I oxide selected from the group consisting of Cs₂O and Rb₂O; about 4 to about 6 mole percent of a lanthanoid oxide; and about 4 to about 6 mole percent of at least one group VB oxide selected from the group consisting of Ta₂O₅ and Nb₂O₅;
wherein said pH glass membrane has a substantially domed shape.

31. The pH glass composition of claim 30, wherein said pH glass membrane has a thickness of about 0.01 inches to about 0.03 inches.

32. The pH glass composition of claim 30, wherein said pH glass membrane has a resistivity between about 10 MΩ and about 30 MΩ.

33. A pH sensor comprising:
a reference electrode;
a measuring electrode operatively connected to said reference electrode;
a fluid conduit for containing an electrolyte in electrolytic contact with said reference electrode;
a reservoir in fluid communication with said fluid conduit;
a reference junction encasing said reference electrode; and,
an external junction;
where said electrolyte comprises a viscous silica suspension.

34. The pH sensor of claim 33 wherein said viscous silica suspension comprises fumed silica.

35. The pH sensor of claim 33, wherein said measuring electrode further comprises a pH glass membrane.

36. The pH sensor of claim 35, wherein said pH glass membrane has a substantially dome shape.

37. The pH sensor of claim 35, wherein said pH glass membrane comprises a glass composition comprising:
about 33 to about 36 mole percent Li₂O; about 0.5 to about 1.5 mole percent of at least one oxide selected from the group consisting of Cs₂O and Rb₂O; about 4 to about 6 mole percent of a lanthanoid oxide; about 4 to about 6 mole percent of at least one oxide selected from the group consisting of Ta₂O₅ and Nb₂O₅; and about 54 to about 58 mole percent SiO₂.

38. The pH sensor of claim 35, wherein said pH glass membrane has a thickness of about 0.01 inches to about 0.03 inches.

39. The pH sensor of claim 37, wherein said glass composition comprises about 34 mole percent Li₂O; about 1.0 mole percent Cs₂O; about 5 mole percent La₂O₃; about 5 mole percent Ta₂O₅; and about 55 mole percent SiO₂.

40. The pH sensor of claim 1, wherein the porous member controls the flow of the electrolyte to reduce inward diffusion through said external junction.

41. The pH sensor of claim 33, wherein the viscous silica suspension reduces inward diffusion through said external junction.
